(19) United States
(12) Patent Application Publication
(10) Pub. No.: US 2008/0186514 A1
(43) Pub. Date: Aug. 7, 2008

(54) Method For Optical Chassis Measurement

(75) Inventors: Volker Uffenkamp, Ludwigsburg (DE); Guenter Nobis, Nuertingen (DE)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 11/909,266

(22) PCT Filed: Nov. 16, 2006
(86) PCT No.: PCT/EP2006/068545

§ 371 Date: Sep. 21, 2007

(30) Foreign Application Priority Data
Dec. 29, 2005 (DE) 10 2005 063 083.9

(51) Int. Cl. G01B 11/14

(52) U.S. Cl. 356/623

(57) ABSTRACT

The invention relates to a method for optically measuring a chassis at a testing station. According to said method, radiation that is reflected by several optically distinguishable characteristic structures on a vehicle, comprising at least one wheel and a surrounding bodywork section, is detected by a measuring device with the aid of an image capture unit and at least the wheel plane and the wheel centre point are determined by an evaluation of the positional data obtained by means of the detected radiation. To obtain reliable measurement results relatively simply, several planes are projected at least onto the wheel (5) and the surrounding bodywork using structured light that is emitted by at least one radiation source of the measuring device, and the intersection of the planes with the wheel (5) and the surrounding bodywork or with a sub-section of the wheel and bodywork is captured as profile lines (3D point cloud) by means of at least one image capture unit, on the basis of a known geometrical assignment of the radiation source or sources to the image capture unit or units. From the intersection points of the profile lines with e.g. the edge of the rim or other rotationally symmetrical contours on the wheel and the wheel opening, the spatial position of characteristic surface points is determined, said points being used to directly determine the relevant chassis data.

The invention relates to a method for optical chassis measurement at a testing station, in which, out of a plurality of optically differentiable characteristic structures on a vehicle, radiation reflected against at least one wheel and a surrounding chassis opening is detected by an image capture device and, through evaluation of position data acquired from the detected radiation, at least the wheel plane and the wheel center point are determined.

### PRIOR ART

A method for optical chassis measurement of this kind has been disclosed by DE 197 57 763 A1 and also in similar fashion by EP 1 042 643 B1. In these known methods, cameras are used to detect reference features of the testing station as well as wheel features and chassis features and, on the basis of this information, the axis of travel and suspension geometry data of the wheel and axle are determined; according to DE 197 57 763 A1, the measurement is carried out while the vehicle is at rest and in the method according to EP 1 042 643 B1, the measurement is carried out while the vehicle is driven past measuring device. In order to detect the features, ambient light in the testing station region is used; the features, in particular of the wheel and the chassis, can be affixed marks or other existing characteristic structures. It is also possible, however, for a special illumination to be provided on the measuring device, for example by means of LEDs; it is also possible for specially retroreflecting measuring marks to be affixed to the wheel and the chassis. These publications also furnish further details regarding the type and detection of suspension geometry data of the wheel and axle based on the geometrical information acquired by means of the marks and/or surface structures and they also mention additional patent applications based thereon. In practice, it has turned out that in order to obtain precise, reliable measurement results, it is useful to affix easily detectable marks; although these known systems have on the whole been able to considerably simplify the measurement in comparison to other systems of chassis measurement, adapting these marks to the wheel and chassis does in fact require a not insignificant amount of effort.

### ADVANTAGES OF THE INVENTION

The object of the present invention is to provide a method for optical chassis measurement that can obtain the most precise, reliable measurement results possible, with the least amount of effort.

This object is attained with the defining characteristics of claim 1. In this case, structured light emitted by at least one radiation source of the measuring device is projected against at least the wheel and the surrounding chassis in a plurality of planes, e.g. by means of a slit diaphragm situated in front of or within the projection optics, and the intersections of the planes with the wheel and the surrounding chassis or a subregion thereof are recorded in the form of profile lines by means of at least one image capture device on the basis of the geometrically known association of the at least one radiation source and the at least one image capture device, with the recording being executed by acquiring a three-dimensional aggregate of points; where applicable, based on points at which the profile lines intersect, for example, with the wheel rim edge or other rotationally symmetrical contours on the wheel and with the wheel opening, the spatial positions of characteristic surface points are determined as position data based on which the chassis data of interest can be directly determined.

This makes it unnecessary to affix and adapt measurement marks to the vehicle wheel and chassis while the measurement device, based on existing surface structures and using the above-mentioned techniques, reliably and unambiguously acquires the surface points consulted for the measurement and subjects them to evaluation so as to obtain precise measurement results, particularly if powerful processors and computers, in connection with image capture devices such as cameras, are used for the image capture and evaluation. The precision can be increased by increasing the number of surface profiles; by using corresponding algorithms, it is also possible to use averaging to compensate for a possibly reduced individual precision. The elimination of an adaptation of marks to the wheel and chassis significantly simplifies operation of the suspension measurement system, among other things because the measurement does not involve a limitation with regard to the material of chassis, removal of hub caps, or additional expenditure of effort for the adaptation.

The evaluation benefits from the fact that through the projection of the planes, specific individual profiles or the entire surface structure of the object sections of interest, at least of the wheel and of the chassis opening, are recorded and also benefits from the use of a light-section method, a gray code method with an encoded light setup, or a phase-shift method.

The measurement is advantageously executed so that in order to determine the wheel plane, the wheel center point, and, where applicable, the chassis opening around the wheel, a multitude of surface points in the form of a 3-D aggregate of points are consulted, but at least three intersecting points between two surface profiles and rotationally symmetrical contours of the wheel, for example of the wheel rim edge are used.

An important application lies in the fact that the load state of the wheel can be determined based on the edge of the wheel opening, while track and camber can be determined based on the wheel plane and the wheel center point.

Other advantages for the measurement arise from the fact that in the scanning, significant surface features on the wheel such as the valve, hole pattern, labeling, dirt, and/or a damaged region are detected and, based on these surface features, a wheel rim eccentricity is detected when the wheel is rotating (e.g. when rolling on the road surface) and taken into account in subsequent evaluation.

An advantageous measurement method is comprised in that the measurement is carried out as the vehicle is driven past and travel direction data are acquired based on a detection of the movement direction of chassis surface structures.

### DRAWINGS

The invention will be explained in greater detail below in conjunction with exemplary embodiments with reference to the drawings.

FIG. 1 is a schematic, partial depiction of a testing station viewed in the direction of travel, with a measuring device and a part of a vehicle to be measured and

FIG. 2 is a detail of the testing station according to FIG. 1, viewed from the side.

### DISCLOSURE OF THE INVENTION

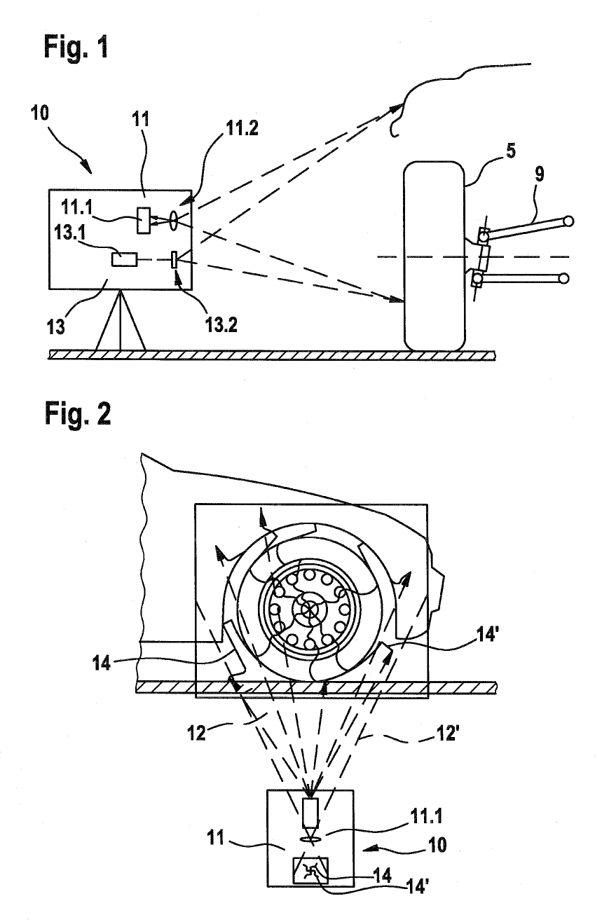

FIG. 1 shows a measuring instrument of a measuring device 10 situated to the side of a vehicle, in the region of a wheel 5. The measuring instrument includes an image capture device 11, which is equipped with an image sensor 11.1 and imaging optics 11.2, in particular a camera arrangement with at least one camera that advantageously has processors for image processing integrated into it, and at least one measurement plane 12 that is generated by a projector 13. The measuring instrument is also connected to computers whose computing power corresponds to the complexity of the measurement. The measuring device 10 is able to determine a variety of data, particularly with regard to a wheel suspension 9.

As is clear from FIG. 2, a radiation source 13.1, in particular a laser, projects one or more planes 12, 12′ into the measurement chamber by means of a slit diaphragm situated in front of or within the projection optics 13.2, which planes intersect the object surface, generating the profile lines 14, 14′ on the measurement object, i.e. the wheel and, where applicable, also the chassis surrounding it. The projected planes 12, 12′ can also be generated by another type of projection device (e.g. a video projector). As a result of the geometric arrangement of the projection device 13 and camera 11, the camera records the intersection of the plane 12, 12′ with the object in the form of a profile line 14, 14′, which is more or less curved, depending on the surface topography. The vertical profile based on digital images is three-dimensionally determined using the principle of the triangulation technique. At each profile point, there is a two-dimensional image coordinate. If the association between the camera and the projection device is known, then the intersection of the image beam with the plane is used to determine the spatial position of the surface point. Through corresponding structuring of the light, it is possible to either record individual profiles or to record the entire surface structure of the object, i.e. the wheel and, where applicable, related sections of the chassis. Various methods are known, namely the light-section method, the gray code method (encoded light setup), and the phase-shift method. The profile lines can advantageously be detected by acquiring a 3-D aggregate of points.

Each vehicle wheel, based on its components such as the tire, wheel rim, hub cap, and valve or the like, has a 3-D surface structure that can be used to measure the wheel and suspension geometry, while each wheel well contour, particularly in the region of the wheel opening, has characteristic features from which is possible to deduce the load state for the respective wheel.

The detection of at least two surface profiles based on the surface structure makes it possible to determine the wheel geometry if the two profiles intersect at least three times with the wheel rim, for example. With a low number of surface profiles, it is advantageous if the sections extend as perpendicularly as possible in relation to the edge of the wheel rim. Based on the at least three wheel rim edge points, it is possible to calculate the wheel plane and the wheel center point. These data can be used to obtain the track and camber and, if so desired, other data of interest relating to the wheel and suspension geometry.

It is possible to detect significant surface features of the wheel such as the valve, hole pattern, labeling, or other features such as dirt and damage. This makes it possible for a potential wheel rim eccentricity to be detected when the wheel is rotating (e.g. when rolling on the road surface) and taken into account in the evaluation.

If a measurement is executed as the vehicle is driven past, then it is necessary to determine the movement of the chassis relative to the measuring device. Prominent chassis structures on the movement path are used to determine the direction of travel or axis of travel of the moving vehicle.

As a rule, a large object section including part of the chassis and the wheel is detected at the beginning of a measurement. To reduce the required complexity of the measurement, it is possible to adapt the size of the object section to different vehicle types and rim sizes after the object structures of interest have been pinpointed.

What is claimed is:

1. A method for optical chassis measurement at a testing station in which, out of a plurality of optically differentiable characteristic structures on a vehicle, radiation reflected against at least one wheel and a surrounding chassis opening is detected by a measuring device by means of an image capture device and, through evaluation of position data acquired from the detected radiation, at least the wheel plane and the wheel center point are determined, wherein a plurality of planes (12, 12′) of structured light emitted by a radiation source of the measuring device are projected against at least the wheel (5) and the surrounding chassis, and the intersections of the planes (12) with the wheel (5) and the surrounding chassis or a subregion thereof are recorded in the form of profile lines (14, 14′) by means of at least one image capture device and on the basis of the geometrically known association of the at least one radiation source and the at least one image capture device; and where applicable, based on intersecting points of the profile lines (14, 14′) and the wheel rim edge or other rotationally symmetrical contours on the wheel and also based on the wheel opening of the chassis, the spatial position of characteristic surface points are determined as position data, based on which the chassis data of interest are then determined.

2. The method as recited in claim 1, wherein through the projection of the planes, specific individual profiles or the entire surface structure of the object sections of interest, at least of the wheel (5) and of the chassis opening, are recorded.

3. The method as recited in claim 1 or 2, wherein a light-section method, a gray code method with an encoded light setup, or a phase-shift method is used.

4. The method as recited in one of the preceding claims, wherein in order to determine the wheel plane, the wheel center point, and, where applicable, the chassis opening around the wheel, a multitude of surface points in the form of a 3-D aggregate of points are consulted, but at least three intersecting points between two surface profiles and rotationally symmetrical contours of the wheel are used.

5. The method as recited in one of the preceding claims, wherein the load state of the wheel is determined based on the edge of the wheel opening, while the track and camber are determined based on the wheel plane and wheel center point.

6. The method as recited in one of the preceding claims, wherein in the scanning, significant surface features on the wheel such as the valve, hole pattern, and labeling as well as dirt and/or a damaged region are detected and based on these surface features, a wheel rim eccentricity is detected when the wheel is rotating and taken into account in subsequent evaluation.

7. The method as recited in one of the preceding claims, wherein the measurement is carried out as the vehicle is driven past and travel direction data are acquired based on a detection of the movement direction of chassis surface structures.
